(19) United States
(12) Patent Application Publication
(10) Pub. No.: US 2003/0039723 A1
(43) Pub. Date: Feb. 27, 2003

(54) Fermented drink containing high level of natural antioxidants, octacosanol, and beta-glucan and its method of production

(76) Inventor: Cheong-Ho Park, Kyungki-Do (KR)

Correspondence Address: Gerald H. Kiel, Reed Smith LLP, 29th Floor, 599 Lexington Avenue, New York, NY, 10022-7650, US

(21) Appl. No.: 10/218,858

(22) Filed: Aug. 13, 2002

(30) Foreign Application Priority Data
Aug. 14, 2001 (KR) 2001-0049177

(51) Int. Cl. A23L 1/10

(52) U.S. Cl. 426/28

(57) ABSTRACT

This invention is a new type of fermented drink (food) made with effective microorganisms and its method of production. The drink is produced through fermentation by adding effective microorganisms including lactobacillus plantarum and saccharomyces cerevisiae to the heated culture extract of malt, rice bran, seaweeds, purified glucose and yeast extracts. This drink (product) contains many vitalizing ingredients including natural antioxidants, octacosanol and β-glucan.

### CROSS-REFERENCE TO RELATED APPLICATION

This application claims priority from South Korean Application No. 2001-0049177, filed Aug. 14, 2001, which is incorporated herein by reference.

### BACKGROUND OF THE INVENTION

1. Field of the Invention

This invention pertains to the field of fermented drinks for providing energy and strength.

2. Various Fermented Drinks

Various drinks are obtained by fermentation, prepared by adding lactobacillus delblueckii cultured to a starch substrate, such as corn starch, potato starch and sweet potato starch. However, these fermented drinks which are widely used in Japan contain very small amount of antioxidants. Consequently, they do not impart substantial amounts of energizing ingredients to the consumer.

### SUMMARY OF THE INVENTION

I have discovered a fermented drink and a method for making the drink which contains a high count of lactobacillus plantarum in addition to other antioxidants, octacosanol, and β-glucan. This drink contains natural antioxidants as well as octacosanol and β-glucan, as well as other vitalizing ingredients.

The inventive drink is obtained by preparing extracts from the digestion of malt, rice bran, and seaweed with water. The cultured extract is then mixed with glucose and yeast extract and effective microorganisms and the mixture is then subjected to fermentation conditions. The product is then pasteurized and filtered to provide a vitalizing drink.

### DETAILED DESCRIPTION OF THE INVENTION

The inventive drink has certain properties that promote the production of antioxidants and vitalizing ingredients in addition to the antioxidants already contained in the fermented drink. This increases the likelihood of live microbes reaching the intestinal tract in contrast to the traditional drinks with live microbes. Additionally, this invention contains a high lactobacillus plantarum count which increases the ability of the body to fight oxidants.

The inventive drink also contains β-glucan which reduces the cholesterol level in the liver or in the bloodstream by stimulating the production of bile acid from the cholesterol already accumulated in the human body and octacosanol which is believed to be the source of stamina of migrating birds that can fly thousands of miles with little or no rest.

The method for preparing the inventive drink includes as a first step, mixing malt, rice bran, and seaweeds in water, usually distilled, and digesting the mixture for one or two days. The mixture separates into layers and the top layer extract is collected. Purified glucose and yeast extracts are added to this extract and this mixture is then heated at a temperature and for a time sufficient to sterilize it. Usually, a time of twenty minutes and a temperature of 121° C. is sufficient to kill any microbes and provide a sterile mixture. The mixture is then allowed to cool to 35° C. by standing and combination of effective microorganisms is added to this cooled mixture. This mixture is allowed to ferment for three days.

Seaweeds suitable for use in the inventive method include undaria pinnatifida, larninaria, hizikia fasaforme, and enteromorpha as well as mixtures thereof. Laminarin is a type of polysaccharide used by phaeophyta for storing energy. The level of laminarin contained in the seaweeds can fluctuate depending on the season and the growth state of the seaweeds. It is known that β-glucan can lower the absorption of cholesterol, remove cholesterol and its derivatives through the bowel movement, and reduce cholesterol level in the liver on in the bloodstream by stimulating production of bile acid from the cholesterol already accumulated in the body.

Additionally, malt and rice bran contains considerable amount of octacosanol and it has been confirmed through numerous tests that it increases endurance and stamina when taken internally. A summary of the effects on human body of octacosanol is given in “The effect of octacosanol on the endurance type exercise” a research paper jointly published by Prof. Eusoo Ahn (Sports Medicine, Seong Kyun Kwan University), Byungcheol Ahn (Scientific Support, Samsung Sports), Wansoo Kim (Study of Circulatory Organs, Ahjoo Medical University), and Soowan Lee (Food and Life Resource Study, Seong Kyun Kwan University). As stated therein, the effects are as follows:

1. it increases the amount of muscle glycogen increasing muscle strength and muscle endurance,

2. it not only increases the amount of stored energy, but also shortens the usage time, thereby improving reaction time and reflex,

3. it increases the utilization rate of fatty acids by muscles,

4. it increases maximum oxygen absorption and reduces cardiac loading,

5. it improves blood coagulation properties and cardio functions,

6. it reduces the LDL level and increases the HDL level,

Compounding of the effective microorganisms is achieved by mixing lactobacillus plantarum and saccharomyces cerevisiae, less than 0.2% of Rhodopseudomonas capulata and Streptomyces griseus are mixed to achieve the intended effect.

The idea of using Rhodopseudomonas capsulata and Streptomyces griseus is obtained from the discovery by Froidvoch in 1969 that S.O.D. breaks down superoxide free radicals. This started the theory that activated oxygen plays a role in the aging process and sparked much research in the use of natural antioxidants in the prevention of aging. The new discovery that new kinds of natural antioxidants and other vitalizing substances can be produced by effective microorganisms such as the lactobacillus plantarum as well as the saccharomyces cerevisiae, Rhodopseudomonas capsulata, Streptomyces griseus and fungi also provided support for this theory.

The fermented extracts obtained from the inventive methods are pasteurized using infrared, and then they are filtered through a ceramic filter. Refreshing drink can be produced by adding additional distilled water, sweetener, and fragrances.

The microorganisms described herein are known and readily available, for example, from the Biochemical Engineering Laboratory of Korea Advanced Institute of Science and Technology (KAIST) located in Daejeon, South Korea.

The following example is illustrative of the invention;

### EXAMPLE

8 kgs of malt, 6 kg of rice bran, 5 kgs of seaweeds are digested in 600 liters of distilled water for 24˜48 hours. The top layer extract is collected and placed into a one ton capacity fermentation tank. 9 kgs of purified glucose and 1.8 kgs of yeast extracts are added to accelerate fermentation while stirring. This mixture is than heated at 121° C. for 20 minutes and cooled to 35° C. by standing. Effective microorganisms are added and the mixture is fermented for 3 days to produce the desired culture extracts.

The following chart is obtained from analysis of the refined fermented drink.

| | | |
|---|---|---|
| Item | Amount | Note |

| | |
|---|---|
| Natural antioxidants (FRAP assay) | 117 mg/R ascorbic acid |
| β-glucan | 0.67% |
| Octacosanol | 25.31 PPM |
| S.O.D. activity | Not present |
| Lactobacillus plantarum | 1.8 × 10⁹ cfu/ml |
| Ammonia nitrogen | 51.79 PPM |
| Germs | Negative |
| Arsenic | Not present |
| Heavy metals | Not present |
| Cadmium | Not present |
| Aflatoxin | Not present |
| Escherichia coli | Not present |

As illustrated from the above example, this fermented drink has higher levels of antioxidants, better delivery through the intestine, and higher lactobacillus plantarum counts compared to the traditional lactobacillus drinks. In addition, it contains octacosanol and β-glucan. Antioxidants found in the drink prevent physical aging, increase stamina, improve the self-healing capacity, and prevent geriatric diseases. Combined with the β-glucan that lowers the cholesterol level and increases the immune response and octacosanol that improves cardio vascular endurance, sports endurance, post exercise recovery time, and reduces the feeling of exertion, it can truly be said that it is a multi purpose fermented drink.

What is claimed is:

1. A method for preparing a fermented drink containing natural antioxidants, octacosanol, β-glucan comprising:
a. preparing a mixture of malt, rice bran, seaweed, and water;
b. digesting the mixture at room temperature for a period of from one to two days to form a top and bottom layer;
c. separating the top layer;
d. heating the top layer for a time and at a temperature sufficient to kill any microbes therein;
e. adding purified glucose, yeast extract and effective microorganisms to the mixture obtained from step d. and subjecting the mixture with the microorganisms therein to fermentation conditions for a period of about three days at ambient temperature;
f. pasteurizing the fermented mixture, and removing the solids therefrom to obtain a filtered liquid drink.

2. The method of claim 1 wherein step d. is carried out at a temperature of about 121° C. and for about 20 minutes and followed by cooling the mixture to a temperature of about 35° C.

3. The method of claim 1 wherein the seaweed is selected from the group consisting of undaria, pinnatifida, larninaria, hizikia, fasaforme, and mixtures thereof.

4. The method of claim 1 wherein the effective microorganisms are selected from the group consisting of lactobacillus plantarum, saccharomyces cerevisiae, Rhodopseudomonas capsulate, Streptomyces griseus, and mixtures thereof.

5. The method of claim 1 wherein the drink is further diluted with distilled water.

6. The method of claim 1 wherein an additive selected from the group consisting of sweeteners, fragrance, and mixtures thereof is added to the drink.

7. The method of claim 4 wherein less than 0.2% of Rhodopseudomonas capsulata is added.

8. The method of claim 4 wherein the drink obtained contains more than 1.0×10⁹ cfh/ml of lactobacillus plantarum.

9. The drink produced by the method of claim 1.

10. The drink produced by the method of claim 2.

11. The drink produced by the method of claim 3.

12. The drink produced by the method of claim 4.

13. The drink produced by the method of claim 5.

14. The drink produced by the method of claim 6.

15. The drink produced by the method of claim 7.

16. The drink produced by the method of claim 8.
